(19) United States
(12) Patent Application Publication
(10) Pub. No.: US 2013/0157845 A1
(43) Pub. Date: Jun. 20, 2013

(54) SORBENTS FOR REMOVING MERCURY FROM EMISSIONS PRODUCED DURING FUEL COMBUSION

(71) Applicants: Christopher J. Nalepa, Zachary, LA (US); William S. Pickrell, Baton Rouge, LA (US); Gregory H. Lambeth, Baton Rouge, LA (US); Qunhui Zhou, Baton Rouge, LA (US)

(72) Inventors: Christopher J. Nalepa, Zachary, LA (US); William S. Pickrell, Baton Rouge, LA (US); Gregory H. Lambeth, Baton Rouge, LA (US); Qunhui Zhou, Baton Rouge, LA (US)

(73) Assignee: ALBEMARLE CORPORATION, Baton Rouge, LA (US)

(21) Appl. No.: 13/819,455

(22) PCT Filed: Aug. 19, 2011
(86) PCT No.: PCT/US2011/048454

§ 371 Date: Feb. 27, 2013

Related U.S. Application Data
(60) Provisional application No. 61/378,208, filed on Aug. 30, 2010.

(51) Int. Cl. B01J 20/20; B01D 53/64

(52) U.S. Cl. CPC B01J 20/20; B01D 53/64
USPC 502/401; 502/417; 252/182.11; 252/182.12; 252/182.32; 252/182.35; 423/283; 423/317; 423/413; 423/522; 423/545; 423/567.1; 423/210; 564/63; 95/134

(57) ABSTRACT

Activated carbon is rendered more thermally stable by exposure to a non-halogenated additive, and optionally to a halogen and/or a halogen-containing compound. Such treated carbon is suitable for use in mitigating the content of hazardous substances in flue gases, especially flue gases having a temperature within the range of from about 100° C. to about 420° C.

### BACKGROUND

It has become both desirable and necessary to reduce the hazardous substance content of industrial flue gasses. The hazardous substances can have a deleterious affect on the public health and the environment. Industry and government have been working to reduce the emissions of such substances with good progress being made. Special focus has been on flue gas from coal-fired boilers, such as that found in electric generation plants. Recent focus has also been on emissions from cement kilns. But there is more to do. Hazardous substances include particulates, e.g. fly ash, acid gases, e.g. SOx, NOx, as well as dioxins, furans, heavy metals and the like.

The methods used to mitigate the emission of hazardous substances depend on the nature of the hazardous substance, the minimum emission level sought, the volume of emitted gas to be treated per unit time and the cost of the mitigating method. Some hazardous substances lend themselves to removal from gaseous effluent by mechanical means, e.g. capture and removal with electrostatic precipitators (ESP), fabric filters (FF) or wet scrubbers. Other substances do not lend themselves to direct mechanical removal.

Hazardous gaseous substances that are present in a gaseous effluent present interesting challenges, given that direct mechanical removal of any specific gaseous component from a gas stream is problematic. However, it is known, and an industrial practice, to remove hazardous gaseous components from a gaseous effluent by dispersing a fine particulate adsorbent evenly in the effluent to contact and capture, in flight, the targeted gaseous component. This is followed by mechanical removal of the adsorbent with its adsorbate from the effluent vapor by ESP, FF or wet scrubbers. A highly efficacious adsorbent is carbon, e.g., cellulosic-based carbons and coal-based carbons in a form such as powdered activated carbon (PAC). Such PACs, for example, can be used with or without modification. Modified PACs may enhance capture of the target hazardous substance by enhancing adsorption efficiency. PAC modification is exemplified by U.S. Pat. No. 4,427,630; U.S. Pat. No. 5,179,058; U.S. Pat. No. 6,514,907; U.S. Pat. No. 6,953,494; US 2001/0002387; US 2006/0051270; and US 2007/0234902. Cellulosic-based carbons include, without limitation, carbons derived from woody materials, coconut shell materials, or other vegetative materials. Coal-based PACs include, without limitation, carbons derived from peat, lignite, bituminous, anthracite, or other similar sources.

A problem with the use of carbons in industrial applications, is their unreliable thermal stability, that is, the lack of assurance that they are resistant to self-ignition. Self-ignition is especially problematic when the carbon is used in the treatment of warm or hot gaseous effluents or when packaged or collected in bulk amounts. For example, bulk PAC is encountered (i) when the PAC is packaged, such as in super-sacks or (ii) when formed as a filter cake in an FF unit or is collected in silos or hoppers associated with an ESP, TOXECON unit, and baghouse. Self-ignition results from unmitigated oxidation of the carbon and can lead to its smoldering or burning. Self-ignition is exacerbated by the carbon being warm or hot, as could be the case when used in treating coal-fired boiler effluents. If oxygen (air) is not denied to the oxidation site or if the site is not cooled, the heat from the initial oxidation will propagate until the carbon smolders or ignites. Such an ignition can be catastrophic. Utility plants are especially sensitive about self-ignition as smoldering or fire within the effluent line can cause a plant shut-down with widespread consequences to served customers.

Further information on PAC thermal stability can be found in U.S. Pat. No. 6,843,831, “Process for the Purification of Flue Gas.” Some carbons are more resistant to self-ignition than others. For example, in the US, the use of coal-derived PACs is often employed for utility flue gas treatment, in part because of the generally recognized good thermal stability of coal-derived PACs.

It would be advantageous if PACs of lesser thermal stability, such as those derived from certain cellulosic-based carbons could be modified to be more thermally stable so that the practitioner could enjoy the benefit of the excellent adsorption qualities of cellulosic-based carbons. It would also be advantageous to improve the thermal stability of certain coal-based PACs, such as, those that are lignite-based, since even these carbons have been associated with self-ignition and smoldering events.

### THE INVENTION

This invention meets the above-described needs by providing an activated carbon that has been exposed to a non-halogenated additive comprising sulfur, sulfuric acid, sulfamic acid, boric acid, phosphoric acid, ammonium sulfate, urea, ammonium sulfamate, monoammonium phosphate, diammonium phosphate, melamine, melamine phosphate, boric acid/borate combination, silica gel/sodium carbonate, or urea/formaldehyde and, optionally to a halogen and/or a halogen-containing compound, and that has at least one of the following: (i) a temperature of initial energy release that is greater than the temperature of initial energy release for the same activated carbon without the exposure to the non-halogenated additive and, optionally, to the halogen and/or the halogen-containing compound; (ii) a self-sustaining ignition temperature that is greater than the self-sustaining ignition temperature for the same activated carbon without the exposure; or (iii) an early stage energy release value that is less than the early stage energy release value for the same activated carbon without the exposure. It is believed that any one or more of the qualities recited in (i), (ii) and (iii) is indicative of an enhancement of the thermal stability of an activated carbon exposed to one or more non-halogenated additives, and optionally to a halogen and/or a halogen-containing compound, according to this invention as compared to the same activated carbon without the exposure. This invention also relates to a process for enhancing the thermal stability of activated carbon. The process comprises exposing the activated carbon to a non-halogenated additive comprising sulfur, sulfamic acid, boric acid, phosphoric acid, ammonium sulfate, urea, ammonium sulfamate, monoammonium phosphate, diammonium phosphate, melamine, melamine phosphate, boric acid/borate combination, silica gel/sodium carbonate, or urea/formaldehyde and, optionally, to a halogen and/or a halogen-containing compound, at a temperature and for a time sufficient so that the exposed activated carbon has at least one of the following: (i) a temperature of initial energy release that is greater than the temperature of initial energy release for the same activated carbon without the exposure to the non-halogenated additive and, optionally to the halogen and/or the halogen-containing compound; (ii) a self-sustaining ignition temperature that is greater than the self-sustaining ignition temperature for the same activated carbon without the exposure; or (iii) an early stage energy release value that is less than the early stage energy release value for the same activated carbon without the exposure. This invention also relates to a process for mitigating the atmospheric release of gaseous hazardous substances from flue gases containing such substances, the process comprising contacting the flue gas with activated carbon that has been exposed to a non-halogenated additive comprising sulfur, sulfamic acid, boric acid, phosphoric acid, ammonium sulfate, urea, ammonium sulfamate, monoammonium phosphate, diammonium phosphate, melamine, melamine phosphate, boric acid/borate combination, silica gel/sodium carbonate, or urea/formaldehyde and, optionally, to a halogen and/or a halogen-containing compound, and that has at least one of the following: (i) a temperature of initial energy release that is greater than the temperature of initial energy release for the same activated carbon without the exposure to the non-halogenated additive and, optionally to the halogen and/or the halogen-containing compound; (ii) a self-sustaining ignition temperature that is greater than the self-sustaining ignition temperature for the same activated carbon without the exposure; or (iii) an early stage energy release value that is less than the early stage energy release value for the same activated carbon without the exposure.

The activated carbons of this invention can be, as before noted, derived from both cellulosic-based and coal-based materials.

The production of activated cellulosic-based carbons, e.g., wood-based PACs, is well known and generally entails either a thermal activation or chemical activation process. For more details see, Kirk-Othmer Encyclopedia of Chemical Technology, 4^{th} Edition, Volume 4, pages 1015-1037 (1992). The activated wood-based carbon can be produced from any woody material, such as sawdust, woodchips, coconut shell materials, or other vegetative materials. The production of activated coal-based carbons, e.g., lignite-based PACs, are produced by similar processes.

Activated cellulosic-based carbons are commercially available. For example, activated wood-based carbons can be obtained from MeadWestvaco Corporation, Specialty Chemical Division. Activated coal-based carbons are also commercially available. Activated lignite-based carbons can be obtained from Norit Americas, Inc., whilst activated bituminous-based carbons can be obtained from Calgon Corporation. Activated carbons can be characterized by their particle size distribution (D¹⁰, D⁵⁰ and D⁹⁰); average particle size; BET surface area; Iodine No.; total pore volume; pore volume distribution (macro/meso and micro pores); elemental analysis; moisture content; and ash speciation and content. Particularly useful activated carbons have one or more of the following characteristics:

| Characteristic | General Range | Specific Range |
|---|---|---|
| D¹⁰ | 1-10 μm | 2-5 μm |
| D⁵⁰ | 5-35 μm | 10-20 μm |
| D⁹⁰ | 20-100 μm | 30-60 μm |
| Average Particle Size: | 10-50 μm | 5-25 μm |
| BET: | >300 m²/g | >500 m²/g |
| Iodine No.: | 300-1200 mg/g | >600 mg/g |
| Total Pore Volume: | 0.10-1.20 cc/g | 0.15-0.8 cc/g |
| Macro/Meso Pore Volume: | 0.05-0.70 cc/g | 0.05-0.40 cc/g |
| Micro Pore Volume: | 0.05-0.50 cc/g | 0.10-0.40 cc/g |
| Ash Content: | 0-15 wt % | <10 wt % |
| Moisture Content: | 0-15 wt % | <5 wt % |

A non-halogenated additive comprising sulfur, sulfamic acid, boric acid, phosphoric acid, ammonium sulfate, urea, ammonium sulfamate, monoammonium phosphate, diammonium phosphate, melamine, melamine phosphate, boric acid/borate combination, silica gel/sodium carbonate, or urea/formaldehyde can be used in treating carbons in accordance with this invention.

The halogen and/or the halogen-containing compound optionally used in treating cellulosic-derived carbons in accordance with this invention can comprise bromine, chlorine, fluorine, iodine, ammonium bromide, other nitrogen-containing halogen salts, sodium bromide, calcium bromide, potassium bromine, other inorganic halides, etc.

The non-halogenated additive and, optionally, the halogen and/or halogen-containing compound treatment of the carbons can be affected by batch or continuous methods. A suitable batch process feeds the carbon to a tumble reactor/dryer whereupon it is mixed with the non-halogen compound. The non-halogen compound can be added as a crystalline material, dry powder, slurry or solution depending upon the physical and/or solubility properties of the non-halogen compound. Upon completion of the feed of non-halogen compound, the treated carbon material can be dried as needed, especially if its moisture content exceeds 5 wt % based on the total weight of the fed carbon. In one application, gaseous Br₂, at its boiling point temperature, is optionally fed to the reactor/dryer at an initial temperature of from about 75° C. to about 82° C. The reactor/dryer pressure is conveniently kept at around ambient pressure. The dryer is run in the tumble mode during and after the feed. The post-feed tumble period is from about 30 minutes to an hour. Quantitatively, the amount of Br₂ fed corresponds identically or nearly identically with the desired bromine content of self-ignition resistant carbon. For example, if a self-ignition resistant carbon having a bromine content of about 5 wt % is desired, then the amount of Br₂ fed is 5 parts Br₂ per 95 parts of treated carbon. The Br₂ feed rate is essentially uniform throughout the Br₂ feed period. After the post feed tumble period, the self-ignition resistant carbon is removed from the reactor/dryer to storage or packaging.

A suitable continuous process for treating carbon features a separate feed of non-halogenated additive, and optionally, the halogen and/or halogen-containing compound, and the carbon to a continuous reactor. The non-halogenated additive and the optional halogen and/or halogen-containing compound can be co-fed as well. The particulate carbon is conveniently transported to and through the continuous reactor by a gas such as air and/or nitrogen. To enhance mixing, a downstream eductor can be used to insure turbulent mixing. Quantitatively, the same proportions used as in the batch method are used in the continuous method.

In both the batch and continuous modes it may be preferable, depending upon the properties of the non-halogenated additive, to introduce the optional halogen and/or halogen-containing compound prior to introduction of the non-halogenated additive by methods described above.

In both the described batch and continuous methods, all of the optional halogen and/or halogen-containing compound is incorporated in the self-ignition resistant carbon material. Thus, it is convenient to refer to the amount of Br₂ in the self-ignition resistant carbon material by reference to the amounts of Br₂ and treated carbon fed to the reactor. A 5 kg feed of Br₂ and a 95 kg feed of treated will be deemed to have produced a gaseous bromine treated self-ignition resistant carbon material containing 5 wt % bromine. However, if a practitioner should desire to directly measure the incorporated bromine, such measure can be affected by Schöniger Combustion followed by silver nitrate titration.

The optional halogen and/or halogen-containing self-ignition resistant carbon material can contain from about 2 to about 20 wt % halogen, the wt % being based on the total weight of the self-ignition resistant carbon. A wt % halogen value within the range of from about 5 to about 15 wt % is especially useful when treating flue gas from coal-fired boilers.

Several techniques exist for determining the thermal properties of materials. For example, one can determine (i) the temperature of initial energy release; (ii) the self-sustaining ignition temperature; and/or (iii) the early stage energy release values. For these determinations it is useful to have a Differential Scanning calorimetry (DSC) trace of the heat flow values vs temperature (° C.) of the treated and untreated activated cellulosic-based carbon samples as they are controllably heated. The DSC conditions can be as follows: the sample size is about 10 mg; the carrier gas is air at a flow rate of 100 ml/minute; the temperature ramp rate is 10 degrees centigrade/minute from ambient temperature to 850° C. The DSC can be run on a TA Instruments Thermal Analyst 5000 Controller with Model 2960 DSC/TGA module. The DSC traces created from the DSC test results can be analyzed with TA Instruments Universal Analysis Software, version 4.3.0.6. The sample can be dried thoroughly before being submitted to DSC testing. Thermal drying is acceptable, e.g., drying a 0.5 to 5.0 gram sample at a temperature of 110° C. for 1 hour. The values obtained from the DSC testing can be traced on a Heat Flow (watts/gram) versus Temperature (° C.) graph.

The thermal stability of a substance can be assessed, e.g., via the temperature of initial energy release, a.k.a., the point of initial oxidation (PIO) of the substance. As used in this specification, including the claims, the PIO of compositions and/or sorbents of this invention is defined as the temperature at which the heat flow, as determined by DSC, has increased by 1.0 W/g with the baseline corrected to zero at 100° C. PIO has been found to be a good predictor of thermal stability, especially when compared to values for PACs known to generally have suitable thermal stability, i.e. “benchmark carbons.” One such a benchmark carbon is exemplified by the lignite coal derived PAC impregnated with NaBr marketed by Norit Americas, Inc., designated DARCO Hg-LH, which coated PAC has been found to have a PIO value of 343° C.

Another thermal stability assessment method of comparison is the self-sustaining ignition temperature (SIT). The SIT is usually defined as the intersection of the baseline and the slope at the inflection point of the heat flow as a function of temperature curve. The inflection point can be determined using TA Instruments Universal Analysis Software. Generally, the inflection point is defined in differential calculus as a point on a curve at which the curvature changes sign. The curve changes from being concave upwards (positive curvature) to concave downwards (negative curvature), or vice versa.

One final thermal stability assessment method involves determining the early stage energy release values by integration of the DSC trace between 125° C. to 425° C. and between 125° C. to 375° C. The values from these two integrations are each compared against the same values obtained for PACs that are known to generally have suitable thermal stability, i.e. “benchmark carbons.” Such a benchmark carbon is again exemplified by the lignite coal derived PAC designated as DARCO Hg-LH, which has been found to have an early stage energy release values (125° C. to 425° C.) of 1,378 joules/gram and 370 joules/gram for 125° C. to 375° C.

### EXAMPLES

The following examples, summarized in Table 1, are illustrative of the principles of this invention. It is understood that this invention is not limited to any one specific embodiment exemplified herein, whether in the examples or the remainder of this patent application. The general procedure used to prepare the samples comprised blending a solution of non-halogenated additive with activated carbon. Certain non-halogenated additives (e.g., elemental sulfur), due to their special handling and solubility properties, are more preferably blended as a dry powder with the carbon. The activated carbon mixture was dried overnight in a recirculating air oven to provide a treated carbon. The treated carbon was optionally brominated with elemental bromine according to the process disclosed in U.S. Pat. No. 6,953,494 or blended with other halogen sources, such as sodium bromide, potassium bromide, calcium bromide, hydrogen bromide, and/or ammonium bromide.

### Examples 1-56

The following table lists PIO values for a series of samples. The PAC designations are as follows:

DARCO Hg LH—commercially-available lignite-based powdered activated carbon treated with sodium bromide; particle size, avg.=18.1 μm.

TWPAC—thermally-activated wood-based powdered activated carbon, from MeadWestvaco; particle size=15.4 μm; surface area=756 m²/g; pore diameter, avg.=21.0 Å.

CCN—activated coconut-based powdered activated carbon, from Jacobi; particle size, avg.=20.7 μm.

CWPAC—chemically-activated wood-based powdered activated carbon, from MeadWestvaco; particle size=16.2 μm.

TABLE 1
Thermal Properties of Cellulosic PACs Treated with Non-Halogenated
Additives and (Optionally) Sources of Halogen

| | Activated | | PIO |
|---|---|---|---|
| Example | Carbon | Treatment | (° C.) |
| 1 (Comparative) | Lignite | DARCO Hg-LH | 343 |
| 2 (Comparative) | TWPAC | None | 266 |
| 3 (Comparative) | TWPAC | Br₂ (5%) | 356 |
| 4 (Comparative) | TWPAC | HCl (3.5%) | 310 |
| 5 (Comparative) | TWPAC | HNO3 (3.5%) | 300 |
| 6 | TWPAC | Sulfamic Acid (3%) | 384 |
| 7 | TWPAC | Sulfamic Acid (10%) | 416 |
| 8 | TWPAC | Sulfamic Acid (3%); Br₂ (5%) | 392 |
| 9 | TWPAC | Sulfamic Acid (1.5%); Br₂ (5%) | 388 |
| 10 | TWPAC | Sulfur (5%) | 402 |
| 11 | TWPAC | Sulfur (2.5%) | 397 |
| 12 | TWPAC | Sulfur (2.5%); Br₂ (5%) | 376 |
| 13 | TWPAC | Sulfur (1.2%); Br₂ (5%) | 378 |
| 14 | TWPAC | Sulfuric Acid (3%) | 309 |
| 15 | TWPAC | Sulfuric Acid (3%); Br₂ (5%) | 386 |
| 16 | TWPAC | Sulfuric Acid (1.5%); Br₂ (5%) | 375 |
| 17 | TWPAC | Boric Acid (5%) | 338 |
| 18 | TWPAC | Boric Acid (5%); Br₂ (5%) | 411 |
| 19 | TWPAC | Phosphoric Acid (5%) | 373 |
| 20 | TWPAC | Phosphoric Acid (5%); Br₂ (5%) | 403 |
| 21 | TWPAC | Ammonium Sulfate (5%) | 399 |
| 22 | TWPAC | Ammonium Sulfate (3.4%) | 384 |
| 23 | TWPAC | Ammonium Sulfate (5%); | 395 |
| | | Br₂ (5%) | |
| 24 | TWPAC | Urea (5%) | 306 |
| 25 | TWPAC | Urea (5%); Br₂ (5%) | 377 |
| 26 (Comparative) | TWPAC | Br₂ (10%) | 370 |
| 27 | TWPAC | Sulfuric Acid (15%); Br₂ (10%) | 413 |
| 28 | TWPAC | Br₂ (10%); Sulfuric Acid (15%) | 421 |
| 29 (Comparative) | TWPAC | NaBr (10%) | 287 |
| 30 (Comparative) | TWPAC | NaBr (5%) | 282 |
| 31 | TWPAC | NaBr (5%); S (2.5%) | 372 |
| 32 | TWPAC | NaBr (5%); | 363 |
| | | Ammonium Sulfate (1.2%) | |
| 33 | TWPAC | NaBr (5%); Sulfamic Acid (5%) | 392 |
| 34 | TWPAC | NaBr (5%); Sulfamic Acid (1.5%) | 358 |
| 35 (Comparative) | TWPAC | KBr (10%) | 276 |
| 36 (Comparative) | TWPAC | KBr (5%) | 270 |
| 37 | TWPAC | KBr (5%); Sulfamic Acid (5%) | 394 |
| 38 | TWPAC | KBr (5%); Sulfamic Acid (1.5%) | 343 |
| 39 (Comparative) | TWPAC | CaBr₂ (10%) | 307 |
| 40 (Comparative) | TWPAC | CaBr₂ (5%) | 347 |
| 41 | TWPAC | CaBr₂ (5%); Sulfamic Acid (5%) | 362 |
| 42 | TWPAC | CaBr₂ (5%); Sulfamic Acid (1.5%) | 320 |
| 43 (Comparative) | TWPAC | aq. HBr (10%) | 305 |
| 44 (Comparative) | TWPAC | aq. HBr (5%) | 338 |
| 45 | TWPAC | aq. HBr (5%); Sulfamic Acid (5%) | 390 |
| 46 | TWPAC | aq. HBr (5%); | 335 |
| | | Sulfamic Acid (1.5%) | |
| 47 (Comparative) | TWPAC | NH₄Br (10%) | 398 |
| 48 (Comparative) | TWPAC | NH₄Br (5%) | 368 |
| 49 | TWPAC | NH₄Br (5%); Sulfamic Acid (5%) | 401 |
| 50 | TWPAC | NH₄Br (5%); | 386 |
| | | Sulfamic Acid (1.5%) | |
| 51 (Comparative) | CCN | None | 320 |
| 52 | CCN | Sulfamic Acid (5%) | 430 |
| 53 | CCN | Sulfamic Acid (5%); Br₂ (5%) | 447 |
| 54 | CCN | Sulfuric Acid (5%) | 433 |
| 55 | CCN | Sulfuric Acid (5%); Br₂ (5%) | 417 |
| 56 | CCN | Boric Acid | 463 |
| 57 | CCN | Boric Acid; Br₂ (5%) | 455 |
| 58 | CCN | Sulfur (2.5%) | 438 |
| 59 | CCN | Sulfur (5%) | 441 |
| 60 | CCN | Sulfur (2.5%); Br₂ (5%) | 443 |
| 61 (Comparative) | CCN | NaBr (5%) | 354 |
| 62 (Comparative) | CWPAC | None | 353 |
| 63 (Comparative) | CWPAC | Br₂ (5%) | 300 |
| 64 | CWPAC | Boric Acid (5%) | 371 |
| 65 | CWPAC | Boric Acid (5%); Br₂ (5%) | 353 |
| 66 | CWPAC | Sulfamic Acid (5%) | 389 |
| 67 | CWPAC | Sulfamic Acid (5%); Br₂ (5%) | 360 |
| 68 | CWPAC | Phosphoric Acid (5%) | 363 |
| 69 | CWPAC | Phosphoric Acid (5%); Br₂ (5%) | 342 |
| 70 | CWPAC | Sulfur (5%) | 378 |
| 71 | CWPAC | Sulfur (2.5%) | 375 |
| 72 | CWPAC | Sulfur (2.5%); Br₂ (5%) | 342 |
| 73 | Lignite | None | 392 |
| 74 | Lignite | Br₂ (5%) | 358 |
| 75 | Lignite | Boric Acid (5%) | 452 |
| 76 | Lignite | Boric Acid (5%); Br₂ (5%) | 416 |
| 77 | Lignite | Sulfamic Acid (5%) | 421 |
| 78 | Lignite | Sulfamic Acid (5%); Br₂ (5%) | 382 |
| 79 | Lignite | Phosphoric Acid (5%) | 423 |
| 80 | Lignite | Phosphoric Acid (5%); Br₂ (5%) | 383 |
| 81 | Lignite | Sulfur (5%) | 410 |
| 82 | Lignite | Sulfur (5%); Br₂ (5%) | 398 |

The following data indicate that the processes of this invention not only improve the thermal properties of brominated and non-brominated activated carbons but also provide good mercury capture results as well. These data were obtained using the mercury capture device described in U.S. Pat. No. 6,953,494.

TABLE 2
Mercury Capture Data for Treated PACs of Examples 2, 3, 8, 10,
12, 15, 18, 20, 23, 25, 26, 27, 28, 29, 30, 33, 36, 40, 47, 48

| Brominated PAC | Mercury Capture, (%, Avg) |
|---|---|
| Example 2 (Comparative) | 46 |
| Example 3 (Comparative) | 72 |
| Example 8 | 75 |
| Example 10 | 50 |
| Example 12 | 77 |
| Example 15 | 75 |
| Example 18 | 76 |
| Example 20 | 73 |
| Example 23 | 70 |
| Example 25 | 71 |
| Example 26 (Comparative) | 79 |
| Example 27 | 76 |
| Example 28 | 53 |
| Example 29 (Comparative) | 71 |
| Example 30 (Comparative) | 69 |
| Example 33 | 59 |
| Example 36 (Comparative) | 61 |
| Example 40 (Comparative) | 68 |
| Example 47 (Comparative) | 74 |
| Example 48 (Comparative) | 69 |

It is to be understood that the reactants and components referred to by chemical name or formula anywhere in the specification or claims hereof, whether referred to in the singular or plural, are identified as they exist prior to being combined with or coming into contact with another substance referred to by chemical name or chemical type (e.g., another reactant, a solvent, or etc.). It matters not what chemical changes, transformations and/or reactions, if any, take place in the resulting combination or solution or reaction medium as such changes, transformations and/or reactions are the natural result of bringing the specified reactants and/or components together under the conditions called for pursuant to this disclosure. Thus the reactants and components are identified as ingredients to be brought together in connection with performing a desired chemical reaction or in forming a combination to be used in conducting a desired reaction. Accordingly, even though the claims hereinafter may refer to substances, components and/or ingredients in the present tense (“comprises”, “is”, etc.), the reference is to the substance, component or ingredient as it existed at the time just before it was first contacted, combined, blended or mixed with one or more other substances, components and/or ingredients in accordance with the present disclosure. Whatever transformations, if any, which occur in situ as a reaction is conducted is what the claim is intended to cover. Thus the fact that a substance, component or ingredient may have lost its original identity through a chemical reaction or transformation during the course of contacting, combining, blending or mixing operations, if conducted in accordance with this disclosure and with the application of common sense and the ordinary skill of a chemist, is thus wholly immaterial for an accurate understanding and appreciation of the true meaning and substance of this disclosure and the claims thereof. As will be familiar to those skilled in the art, the terms “combined”, “combining”, and the like as used herein mean that the components that are “combined” or that one is “combining” are put into a container, e.g., a combustion chamber, a pipe, etc. with each other. Likewise a “combination” of components means the components having been put together in such a container.

While the present invention has been described in terms of one or more preferred embodiments, it is to be understood that other modifications may be made without departing from the scope of the invention, which is set forth in the claims below.

What is claimed is:

1. An activated carbon that has been exposed to a non-halogenated additive comprising sulfur, sulfuric acid, sulfamic acid, boric acid, phosphoric acid, ammonium sulfate, urea, ammonium sulfamate, monoammonium phosphate, diammonium phosphate, melamine, melamine phosphate, boric acid/borate combination, silica gel/sodium carbonate, or urea/formaldehyde and, optionally to a halogen and/or a halogen-containing compound and that has at least one of the following: (i) a temperature of initial energy release that is greater than the temperature of initial energy release for the same activated carbon without exposure to the non-halogenated additive and, optionally to the halogen and/or the halogen-containing compound; (ii) a self-sustaining ignition temperature that is greater than the self-sustaining ignition temperature for the same activated carbon without the exposure; or (iii) an early stage energy release value that is less than the early stage energy release value for the same activated carbon without the exposure.

2. The activated carbon of claim 1 wherein the halogen and/or the halogen-containing compound comprises bromine, chlorine, fluorine, iodine, ammonium bromide, other nitrogen-containing halogen salts, or sodium bromide, potassium bromide, calcium bromide, or other inorganic bromide salts.

3. A process for enhancing the thermal stability of activated carbon, which process comprises exposing the activated carbon to a non-halogenated additive comprising sulfur, sulfuric acid, sulfamic acid, boric acid, phosphoric acid, ammonium sulfate, urea, ammonium sulfamate, monoammonium phosphate, diammonium phosphate, melamine, melamine phosphate, boric acid/borate combination, silica gel/sodium carbonate, or urea/formaldehyde and, optionally to a halogen and/or a halogen-containing compound at a temperature and for a time sufficient so that activated carbon that has been exposed to the non-halogenated additive and, optionally to the halogen and/or the halogen-containing compound has at least one of the following: (i) a temperature of initial energy release greater than the temperature of initial energy release for the same activated carbon prior to exposure to the non-halogenated additive and, optionally to the halogen and/or the halogen-containing compound; (ii) a self-sustaining ignition temperature that is greater than the self-sustaining ignition temperature for the same activated carbon prior to the exposure; or (iii) an early stage energy release value that is less than the early stage energy release value for the same activated carbon prior to the exposure.

4. The process of claim 3 wherein the halogen and/or the halogen-containing compound comprises bromine, chlorine, fluorine, iodine, ammonium bromide, other nitrogen-containing halogen salts, or sodium bromide, potassium bromide, calcium bromide, or other inorganic bromide salts.

5. A non-halogenated additive comprising sulfur, sulfuric acid, sulfamic acid, boric acid, phosphoric acid, ammonium sulfate, urea, ammonium sulfamate, monoammonium phosphate, diammonium phosphate, melamine, melamine phosphate, boric acid/borate combination, silica gel/sodium carbonate, or urea/formaldehyde and, optionally a halogen and/or a halogen-containing compound exposed, activated carbon that contains from about 2 to about 20 wt % halogen and has at least one of the following: (i) a temperature of initial energy release that is greater than the temperature of initial energy release for the same activated carbon prior to exposure to the non-halogenated additive and, optionally the halogen and/or the halogen-containing compound; (ii) a self-sustaining ignition temperature that is greater than the self-sustaining ignition temperature for the same activated carbon prior to the exposure; or (iii) an early stage energy release value that is less than the early stage energy release value for the same activated carbon prior to the exposure.

6. The activated carbon of claim 5 wherein the halogen and/or the halogen-containing compound comprises bromine, chlorine, fluorine, iodine, ammonium bromide, other nitrogen-containing halogen salts, or sodium bromide, potassium bromide, calcium bromide or other inorganic bromide salts.

7. A process for mitigating the atmospheric release gaseous hazardous substances from flue gases containing such substances, the process comprising contacting the flue gas with an activated carbon that has been exposed to a non-halogenated additive comprising sulfur, sulfuric acid, sulfamic acid, boric acid, phosphoric acid, ammonium sulfate, urea, ammonium sulfamate, monoammonium phosphate, diammonium phosphate, melamine, melamine phosphate, boric acid/borate combination, silica gel/sodium carbonate, or urea/formaldehyde and, optionally to a halogen and/or a halogen-containing compound and that has at least one of the following: (i) a temperature of initial energy release that is greater than the temperature of initial energy release for the same activated carbon prior to exposure to the non-halogenated additive and, optionally to the halogen and/or the halogen-containing compound; (ii) a self-sustaining ignition temperature that is greater than the self-sustaining ignition temperature for the same activated carbon prior to the exposure; or (iii) an early stage energy release value that is less than the early stage energy release value for the same activated carbon prior to the exposure.

8. The process of claim 7 wherein the flue gas has a temperature within the range of from about 100° C. to about 420° C.
